(19) United States
(12) Patent Application Publication
(10) Pub. No.: US 2026/0209527 A1
(43) Pub. Date: Jul. 23, 2026

(54) FLAME RESISTANT FOAMED ARTICLE

(71) Applicant: SABIC GLOBAL TECHNOLOGIES B.V., Bergen op Zoom (NL)

(72) Inventors: Junhua ZHANG, Etten-Leur (NL); Jose SALES FERNANDEZ, Maastricht (NL); Gerard Jan Eduard BIEMOND, Brunssum (NL); Emanuel Joseph Herman Marie VAN DER VEN, Waalre (NL); Johannes Gerardus Petrus GOOSSENS, Heeswijk-Dinther (NL)

(21) Appl. No.: 19/140,704

(22) PCT Filed: Dec. 15, 2023
(86) PCT No.: PCT/EP2023/086090

§ 371 Date: Jun. 18, 2025

(30) Foreign Application Priority Data
Dec. 21, 2022 (EP) 22215718.2

(51) Int. Cl. C09D 5/18; B29C 44/02; B29K 23/00; B29K 105/04; C08K 3/22; C08K 5/52

(52) U.S. Cl. CPC C09D 5/18; B29C 44/02; C08K 3/22; C08K 5/52; B29K 2023/12; B29K 2023/14; B29K 2105/04; C08K 2003/2296

(57) ABSTRACT

A flame resistant foamed article and the preparation and use of said foamed article. The foamed article passes UL2335 test when the foamed article is a pallet.

### CROSS REFERENCE TO RELATED APPLICATIONS

This application is a National Stage application of PCT/EP2023/086090, filed Dec. 15, 2023, which claims the benefit of European Application No. 22215718.2, filed Dec. 21, 2022, both of which are incorporated by reference in their entirety herein.

### BACKGROUND

The present invention relates to a flame resistant foamed article. The present invention further relates to the preparation and use of said foamed article.

Foamed article is widely used in various industrial fields for its light weight feature, e.g. the foamed article can be a pallet used for logistic purpose. A pallet is typically a platform on which goods are stored so that they can be lifted and moved using a forklift truck.

It is preferred that a pallet is flame resistant to prevent fire hazard in warehouse environment. UL2335 is a standard for safety fire tests of storage pallets. Pallets passing this standard are known in the art, e.g. US2014155527 discloses a flame retardant polyolefin composition for shipping pallets; U.S. Pat. No. 8,347,794B2 discloses a fire resistant pallet comprising: a pallet assembly having an exterior surface, a fire resistant layer, and said fire resistant layer co-extruded upon said exterior surface of said pallet assembly, said pallet member being molded from a sheet of plastic made of a first liquid melt stream containing fire retardants including intumescent materials and a second liquid melt stream substantially excluding fire retardant materials, and said second liquid melt stream being 2 to 6 times thicker than said first liquid melt stream.

There is still a need in the industry to have a foamed article for light weight purpose and said foamed article is flame resistance and passes UL 2335 when the foamed article is formed into a pallet.

### SUMMARY

Said need is satisfied by a foamed article consisting of a polymer composition, wherein the foaming ratio of the foamed article is in the range from 105 to 120%, wherein the polymer composition comprises a polypropylene wherein the melt flow rate (MFR) of the polypropylene is in the range from 16 to 50 g/10 min as measured according to ISO 1133-1:2011 (230° C., 2.16 kg) and a flame retardant composition comprising at least one phosphate.

### DETAILED DESCRIPTION

It was further found by the inventors of the present invention that the foamed article has excellent balance between stiffness and impact resistance which make it suitable to be formed and/or used as a pallet.

### Polypropylene

The melt flow rate (MFR) of the polypropylene according to the invention is in the range from 16 to 50 g/10 min, preferably from 18 to 40 g/10 min, more preferably from 20 to 29 g/10 min as measured according to ISO 1133-1:2011 (230° C., 2.16 kg).

The polypropylene according to the invention may be a propylene homopolymer, a propylene randome copolymer or a heterophaisc propylene copolymer. Preferably the polypropylene is a heterophaisc propylene copolymer.

Preferably the xylene soluble part of the heterophasic propylene copolymer is in the range from 22 to 35 wt %, preferably from 25 to 32 wt % based on the total amount of the heterophasic propylene copolymer as determined by ISO16152:2005.

Preferably the intrinsic viscosity of the xylene soluble part of the heterophasic propylene copolymer is in the range from 1.5 to 3.0 dl/g, preferably from 1.6 to 2.0 dl/g as measure according to ISO1628-1:2009 in decalin at 135° C.

Preferably the heterophasic propylene copolymer comprises 13 to 20 wt % ethylene-propylene copolymer based on the total amount of the heterophasic propylene copolymer. Preferably the amount of moiety derived from ethylene is in the range from 25 to 55 wt %, preferably from 35 to 52 wt % based on the total amount of the ethylene-propylene copolymer.

Preferably the heterophasic propylene copolymer further comprises a propylene homopolymer matrix, wherein the amount of the propylene homopolymer matrix is in the range of 80 to 87 wt % based on the total amount of the heterophasic propylene copolymer.

In a preferred embodiment, the sum of the propylene homopolymer matrix and the ethylene-propylene copolymer is 100 wt % based on the heterophasic propylene copolymer.

The production process of the polypropylene typically starts with a polymerization step, for example, a multistage polymerization, such as bulk polymerization, gas phase polymerization, slurry polymerization, solution polymerization or any combinations thereof. Any conventional catalyst systems, for example, Ziegler-Natta or metallocene may be used. Such polymerization steps and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably the polymerization process of the polypropylene is performed in the presence of a Ziegler-Natta catalyst. Preferably the Ziegler-Natta catalyst of the present invention is free of phthalate, for example the catalyst comprises compounds of a transition metal of Group 4 to 6 of IUPAC, a Group 2 metal compound and an internal donor wherein said internal donor is a compound selected from optionally substituted malonates, maleates, succinates, glutarates, cyclohexene-1,2-dicarboxylates, citraconate ester, benzoates and derivatives and/or mixtures thereof. Preferably the Ziegler-Natta catalyst comprises a citraconate ester.

### Flame Retardant Composition

The flame retardant composition comprises at least one phosphate, wherein the phosphate is preferably selected from the group consisting of
melamine phosphate,
melamine polyphosphate,
melamine pyrophosphate,
piperazine phosphate,
piperazine polyphosphate,
piperazine pyrophosphate,
2-methylpiperazine monophosphate,
tricresyl phosphate,
alkyl phosphates,
haloalkyl phosphates,
tetraphenyl pyrophosphate,
poly(2-hydroxy propylene spirocyclic pentaerythritol bisphosphate),
poly(2,2-dimethylpropylene spirocyclic pentaerythritol bisphosphonate).

In one embodiment, the flame retardant composition does not comprise an ammonium polyphosphate.

The flame retardant composition is preferably in the form of particles. Preferably the flame retardant composition has a normal particle size distribution (D50) of at least 8 microns as determined by Mastersizer 2000 available from Malvern.

Preferably, the amount of phosphate in the flame retardant composition is in the range from 40 to 75 wt % as measured after treating with nitric acid using ICP-OES spectrometer (iCAP 6300 Duo available from Thermo Fisher)

Preferably, the flame retardant composition comprises piperazine pyrophosphate, melamine phosphate and zinc oxide.

Preferably, the amount of piperazine pyrophosphate is in the range from 40 to 69 wt %, more preferably from 50 to 67 wt %; the amount of melamine phosphate is in the range from 29 to 49 wt % and the amount of zinc oxide is in the range from 1 to 10 wt % based on the total amount of the flame retardant composition.

### Polymer Composition

Preferably the MFR of the polymer composition according to the invention is in the range from 12.0 to 25.0 g/10 min, more preferably from 13.2 to 18.3 g/10 min as measured according to ISO 1133-1:2011 at 230° C., 2.16 kg. The preferred MFR range leads to improved balance between processability and impact resistance of the polymer composition and the foamed article consisting of the polymer composition. The “processability” means whether the polymer composition can be injection foam molded in a stable manner, e.g. sufficient flowability to fill the mold and/or having a substantially uniform foam structure.

Preferably the amount of the polypropylene is in the range from 40 to 82 wt %, preferably from 50 to 81 wt %, even more preferably from 65 to 81 wt % based on the total amount of the polymer composition.

Preferably the amount of the flame retardant composition is in the range from 12 to 40 wt %, preferably from 15 to 30 wt %, more preferably from 16 to 25 wt %, even more preferably from 17 to 19 wt % based on the total amount of the polymer composition.

Preferably a combination of the amount of the polypropylene and the amount of the flame retardant composition is at least 90 wt %, such as 92 wt %, 95 wt % or 98 wt %, based on the total amount of the polymer composition.

The polymer composition further comprises optional additives, wherein the amount of the additives is in the range from 0 to 7 wt %, more preferably from 2 to 4 wt % based on the total amount of the polymer composition.

Preferably the polymer composition comprises limited amount mineral filler for the purpose of reducing density of the polymer composition and the foamed article. E.g. the amount of the mineral filler is at most 5 wt %, preferably at most 3 wt % based on the total amount of the polymer composition. In a preferred embodiment, the polymer composition is free or substantially from of mineral filler.

The polymer composition may be prepared in any conventional melt blending process, for example, the polymer composition may be prepared by melt blending the polypropylene, the flame retardant composition and the optional additives in a twin screw extruder.

It is preferred that the polymer composition has an impact resistance at 23° C. of at least 10 KJ/m2 as measured according to ISO180/1A and a tensile modulus of at least 950 MPa as measured according to ISO517/1A. These properties of the polymer composition lead to excellent balance between stiffness and impact resistance of the foamed article which make it suitable to be formed and/or used as a pallet.

### Foamed Article

The foamed article according to the invention consists of the polymer composition according to the invention.

The foaming ratio of the foamed article is in the range from 105 to 120%, preferably from 106 to 15%, more preferably from 107 to 112%. The foaming ratio is crucial to keep the balance between mechanical properties and density: A low foaming ratio may lead to high density of the foamed article while a high foaming ratio may lead to weak foam structure and render the foam article not suitable for heavy duty use, e.g. for use as a pallet. The foaming ratio is the ratio between the volume of the foamed article and that of the polymer composition prior to foaming, wherein the volume is measured at 23° C.

Generally, to prepare a foamed article, a polymer composition is mixed with a foaming agent. Then the mixture is heated to cause the polymer composition to melt and to cause the foaming agent to yield gas. Depending on the process, the resulting mixture is maintained as a gas-laden melt until it is dispensed in a controlled manner through orifices or into shaping cavities. When the foaming is complete, the foam article is allowed to solidify by cooling. Depending on the desired product shape, the process is either continuous (for example extrusion) or discontinuous, for example with injection molding or expansion foaming. Such processes are known in the art, e.g. from Thermoplastic Foams, by James L. Throne, Sherwood Publishers 1996, hereby incorporated by reference.

In one embodiment, the process for the preparation of the foamed article comprises the steps of:
Providing the polymer composition;
Foam molding the polymer composition into an article, preferably by injection foam molding.

In avoidance of any confusion, “foaming” and “foam molding” have the same meaning in the context of the present invention, it refers to the step in a process that the polymer composition is foamed and converted to the foamed article.

The foaming agent according to the invention can either be a physical foaming agent or a chemical foaming agent, wherein the chemical foaming agent is a chemical that decomposes at specific temperature to liberate gas(es), wherein physical foaming agent are either volatile liquids or gas(es). Typical chemical foaming agent includes but is not limited to azodicarbonamide, sodium bicarbonate and 5-phenyl tetrazole. Preferably the foaming agent is a chemical foaming agent because it is easier to disperse a chemical foaming agent homogeneously in a polymer composition which leads to a more uniform foam structure.

In the embodiment that chemical foaming agent is used in the foam molding step, the obtained foamed article may comprises minor amount of chemical foaming agent residue. Such residue essentially has no influence on the property of the foamed article. In the context of the present invention, the foamed article consists of the polymer composition according to the invention. “consists of” does not exclude the embodiment that the foamed article further comprise minor residue of the foaming agent, e.g. the residue of the foaming agent is at most 0.5 wt %, e.g. at most 0.3 wt %, e.g. at most 0.1 wt %, e.g the foamed article is substantially free of residue of foaming agent.

In a preferred embodiment, the foamed article is a pallet. Preferably the wall thickness of the pallet is in the range from 0.2 to 5 cm, preferably from 1 to 3 cm.

The present invention further relates to the use of the foamed article as a pallet to pass UL2335 test.

### Experiment

### Material

PP 1 is a heterophasic propylene copolymer commercially available from SABIC with grade name SABIC® pp 90910, it has a melt flow rate (MFR) of 22 g/10 min as measured according to ISO 1133-1:2011 (230° C., 2.16 kg). PP1 has a xylene soluble part of 30 wt % as determined by ISO16152:2005, the intrinsic viscosity of the xylene soluble part is 1.7 dl/g as measure according to ISO1628-1:2009 in decalin at 135° C.

PP 2 is a heterophasic propylene copolymer commercially available from SABIC with grade name SABIC® PP CX03-81, it has a melt flow rate (MFR) of 10 g/10 min as measured according to ISO 1133-1:2011 (230° C., 2.16 kg)

PP 3 is a heterophasic propylene copolymer commercially available from SABIC with grade name SABIC® PP PHC27, it has a melt flow rate (MFR) of 14 g/10 min as measured according to ISO 1133-1:2011 (230° C., 2.16 kg). PP3 has a xylene soluble part of 19 wt % as determined by ISO16152:2005, the intrinsic viscosity of the xylene soluble part is 2.1 dl/g as measure according to ISO1628-1:2009 in decalin at 135° C.

Adeka FP2500S is a flame retardant composition commercially available from Adeka, it is a flame retardant composition according to the most preferred embodiment of the present invention.

Additive package consists of 66 wt % black color masterbatch, 11 wt % PTFE powder TSAN INP449 and 23 wt % antioxidant the amount is based on the total amount of the additive package.

### Measurement

The materials were compound in a twin screw extruder to prepare the formulations in Table 1. MFI, Impact resistance and Tensile modulus was measured on unfoamed pellets or injection molded specimens of unfoamed material; Flame resistance was measured on foamed sample with 107% foaming ratio. In the foaming process PALMAROLE BA.M2.E commercially available from ADEKA was used as foaming agent. The foamed sample was prepared by foam injection molding.
MFR was measured according to ISO 1133-1:2011 at 230° C., 2.16 kg;
Impact resistance was measured according to ISO 180/1A;
Tensile modulus was measured according to ISO 527/1A
Flame resistance was measured according to foamed pallets according to UL2335.

### Result

The formulations of examples and their properties are presented in Table 1

TABLE 1

| | CE1 | CE2 | CE3 | CE4 | IE1 |
|---|---|---|---|---|---|
| PP1 (wt %) | | 38 | 38 | | 80.5 |
| PP2 (wt %) | | | 40.5 | 78.5 | |
| PP3 (wt %) | 78.5 | 40.5 | | | |
| Adeka FP2500s | 20 | 20 | 20 | 20 | 18 |
| (wt %) | | | | | |
| Additive package | 1.5 | 1.5 | 1.5 | 1.5 | 1.5 |
| (wt %) | | | | | |
| MFR (g/10 min) | 10.7 | 11.8 | 9.39 | 6.48 | 14.4 |
| Impact | 5.5 | 7.5 | 7.9 | 7.5 | 14.9 |
| resistance 23° C. | | | | | |
| (kJ/m2) | | | | | |
| Impact | 2.7 | 3.3 | 3.4 | 3.1 | 4.2 |
| resistance −20° | | | | | |
| C. (kJ/m2) | | | | | |
| Tensile modulus | Not | Not | Not | Not | 967 |
| (MPa) | measured | measured | measured | measured | |
| Flame resistance | Not | Not | Not | Not | Pass |
| | measured | measured | measured | measured | |

According to Table 1, only IE1 according to the invention has an MFR value 12.0 to 25.0 g/10 min, improved impact resistance at 23° C. and −20° C., a tensile modulus of at least 950 MPa and it passed the UL2335 FR test on foamed pallet with 107% foaming ratio.

1. A foamed article consisting of a polymer composition, wherein the foaming ratio of the foamed article is in the range from 105 to 120%, wherein the polymer composition comprises
a polypropylene being a heterophasic propylene copolymer at an amount in the range from 40 to 82 wt % based on the total amount of the polymer composition, wherein the melt flow rate (MFR) of the polypropylene is in the range from 16 to 50 g/10 min as measured according to ISO 1133-1:2011 (230° C., 2.16 kg), and the xylene soluble part of the heterophasic propylene copolymer is in the range from 22 to 35 wt % based on the total amount of the heterophasic propylene copolymer as determined by ISO16152:2005, and
a flame retardant composition comprising at least one phosphate selected from the group consisting of: melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate).

2. The foamed article according to claim 1 wherein the MFR of the polypropylene is in the range from 18 to 40 g/10 min, as measured according to ISO 1133-1:2011 (230° C., 2.16 kg).

3. (canceled)

4. The foamed article according to claim 1 wherein the xylene soluble part of the heterophasic propylene copolymer is in the range from 25 to 32 wt % based on the total amount of the heterophasic propylene copolymer as determined by ISO16152:2005.

5. The foamed article according to claim 4 wherein intrinsic viscosity of the xylene soluble part of the heterophasic propylene copolymer is in the range from 1.5 to 3.0 dl/g, as measured according to ISO1628-1:2009 in decalin at 135° C.

6. The foamed article according to claim 1 wherein the flame retardant composition comprises piperazine pyrophosphate, melamine phosphate and zinc oxide.

7. The foamed article according to claim 6 wherein the amount of piperazine pyrophosphate is in the range from 40 to 69 wt %; the amount of melamine phosphate is in the range from 29 to 49 wt % and the amount of zinc oxide is in the range from 1 to 10 wt % based on the total amount of the flame retardant composition

8. The foamed article according to claim 1 wherein the amount of the polypropylene is in the range from 50 to 81 wt %, based on the total amount of the polymer composition.

9. The foamed article according to claim 1 wherein the amount of the flame retardant composition is in the range from 12 to 40 wt %, based on the total amount of the polymer composition.

10. The foamed article according to claim 1 wherein the foaming ratio of the foamed article is in the range from 106 to 115%.

11. The foamed article according to claim 1 wherein the MFR of the polymer composition is in the range from 12.0 to 25.0 g/10 min, as measured according to ISO 1133-1:2011 at 230° C., 2.16 kg.

12. A process for the preparation of the foamed article according to claim 1 comprising the steps of:
providing the polymer composition; and
foam molding the polymer composition into an article.

13. The foamed article according to claim 1, wherein the foamed article is a pallet.

14. The pallet according to claim 13 wherein the wall thickness of the pallet is in the range from 0.2 to 5 cm.

15. A method of forming a flame resistant article, the method comprising forming the foamed article according to claim 1 into a pallet, wherein the pallet passes UL2335 test.
